(19) United States
(12) Patent Application Publication
(10) Pub. No.: US 2020/0101957 A1
(43) Pub. Date: Apr. 2, 2020

(54) FRONT VEHICLE BODY STRUCTURE

(71) Applicant: HONDA MOTOR CO., LTD., Tokyo (JP)

(72) Inventors: Kazuki SONODA, Wako-shi (JP); Hei GO, Yokohama-shi (JP)

(21) Appl. No.: 16/582,270

(22) Filed: Sep. 25, 2019

(30) Foreign Application Priority Data
Sep. 27, 2018 (JP) 2018-182359

(51) Int. Cl. B60T 13/74; B62D 25/08; B60T 17/06; B60T 17/04

(52) U.S. Cl. CPC B60T 13/745; B62D 25/082; B60T 2270/82; B60T 17/046; B60T 17/06

(57) ABSTRACT

Provided is a front vehicle body structure of a vehicle equipped with a vehicle brake system including an electric brake actuator that generates a brake hydraulic pressure based on at least a brake pedal operation and a reservoir tank for a brake fluid, the electric brake actuator and the reservoir tank being disposed to be spaced apart from each other in a mounting compartment for a power unit defined in front of a dashboard. The electric brake actuator is eccentrically disposed in the mounting compartment on the left or right side of the vehicle.

A fixing point for fixing a piping tube connecting the electric brake actuator and the reservoir tank is provided on a junction box inside the mounting compartment.

### CROSS-REFERENCE TO RELATED APPLICATION

This application is based upon and claims priority from the Japanese Patent Application No. 2018-182359, filed on Sep. 27, 2018, the entire contents of which are incorporated herein by reference.

### BACKGROUND OF THE INVENTION

### 1. Field of the Invention

The present invention relates to a front vehicle body structure.

### 2. Description of the Related Art

Japanese Patent No. 5715382 discloses a vehicle equipped with electric brakes. In the technique of Japanese Patent No. 5715382, an electric brake actuator for the electric brakes is eccentrically situated in the left side of the engine compartment and a VSA device is eccentrically situated in the right side of the engine compartment. Moreover, the electric brake actuator and the VSA device are connected by piping tubes disposed to extend around a power unit positioned in the center of the engine compartment.

### SUMMARY OF THE INVENTION

Here, in the case where a reservoir tank for the brake fluid and the electric brake actuator are connected by a piping tube, the following problem may occur if the piping tube is routed around a device such as the power unit. Specifically, routing the piping tube in such a manner increases the length of the piping tube, so that the piping tube does not have a substantial height difference. This leads to a problem in that it is difficult to evacuate air in the piping tube.

An object of the present invention is to facilitate the evacuation of air in a piping tube when a reservoir tank and an electric brake actuator are connected to each other with the piping tube.

A front vehicle body structure of the present invention is a front vehicle body structure of a vehicle equipped with a vehicle brake system including an electric brake actuator that generates a brake hydraulic pressure based on at least a brake pedal operation and a reservoir tank for a brake fluid, the electric brake actuator and the reservoir tank being disposed to be spaced apart from each other in a mounting compartment for a power unit defined in front of a dashboard. The electric brake actuator is eccentrically disposed on a left side or a right side of the vehicle in the mounting compartment, and a fixing point for fixing a piping tube connecting the electric brake actuator and the reservoir tank is provided on a junction box inside the mounting compartment.

According to the present invention, it is possible to facilitate the evacuation of air in a piping tube when a reservoir tank and an electric brake actuator are connected to each other with the piping tube.

### BRIEF DESCRIPTION OF THE DRAWINGS

FIG. 1 is a plan view of a mounting compartment for a power unit with the hood of the vehicle removed, showing a front vehicle body structure according to and embodiment of the present invention.

FIG. 2 is a side view of the front vehicle body structure according to the embodiment of the present invention in a state where an electric brake actuator is attached to a side frame of the vehicle.

FIG. 3 is a plan view of the front vehicle body structure according to the embodiment of the present invention in the state where the electric brake actuator is attached to the side frame of the vehicle.

### DETAILED DESCRIPTION OF THE EMBODIMENT

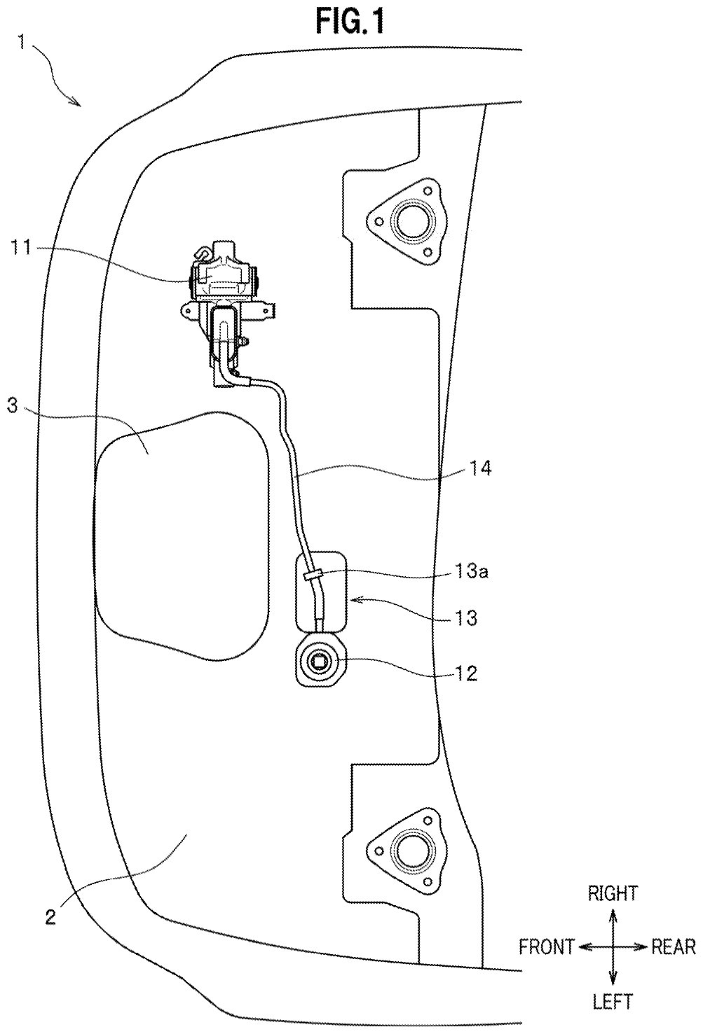

FIG. 1 is a plan view of a mounting compartment for a power unit with the hood of the vehicle removed, showing a front vehicle body structure in an embodiment. In FIG. 1, the front, rear, left, and right sides of a vehicle 1 as viewed by the driver are shown with arrows. A power unit 3 is provided in the front side of a center portion of a mounting compartment 2 for the power unit 3 defined in front (left side in FIG. 1) of the dashboard (not shown) of a vehicle 1. The power unit 3 is a device related to the drive of the vehicle 1.

The vehicle 1 includes a vehicle brake system. This vehicle brake system is an electric brake system. The vehicle brake system includes an electric brake actuator 11 as a drive source for the brakes and a reservoir tank 12 for the brake fluid. The electric brake actuator 11 generates a brake hydraulic pressure at least when the brake pedal (not shown) is operated. In the mounting compartment 2, the electric brake actuator 11 and the reservoir tank 12 for the brake fluid are mounted to be spaced apart from each other.

The electric brake actuator 11 is eccentrically disposed on the left side or the right side of the vehicle 1 in the mounting compartment 2. In this embodiment, the electric brake actuator 11 is eccentrically situated on the right side of the vehicle 1 in the mounting compartment 2. The electric brake actuator 11 is disposed in the right side of the mounting compartment 2 at a position somewhat off to the front and behind a headlight (not shown).

The reservoir tank 12 is disposed in a center portion of the mounting compartment 2 at a position somewhat off to the rear and left. A junction box 13 is disposed to the left of reservoir tank 12. The junction box 13 is a box protecting terminals and terminals and terminal devices used to couple, split, and relay electric wires.

The electric brake actuator 11 and the reservoir tank 12 are connected by a piping tube 14. On the junction box 13, a fixing point 13a for fixing the piping tube 14 is provided. Thus, the piping tube 14 passes over the junction box 13. Further, the piping tube 14 connects the electric brake actuator 11 and the reservoir tank 12 via relatively the shortest path, without extending around various pieces of equipment. Specifically, the positional relation between the electric brake actuator 11 and the reservoir tank 12 is such that the piping tube 14 must be routed around various pieces of equipment unless it is passed over the junction box 13. The piping tube 14 is sloped for air evacuation while connecting the electric brake actuator 11 and the reservoir tank 12.

The axial direction of a stroke direction shaft that is driven inside the electric brake actuator 11 is the longitudinal direction of the electric brake actuator 11. Moreover, the electric brake actuator 11 is disposed such that its longitudinal direction is the left-right direction of the vehicle 1 inside the mounting compartment 2. Thus, the axial direction of the stroke direction shaft of the electric brake actuator 11 is the left-right direction of the vehicle 1 inside the mounting compartment 2. Note that the axial direction of the stroke direction shaft of the electric brake actuator 11 is not limited to the left-right direction of the vehicle 1 inside the mounting compartment 2. The axial direction of the stroke direction shaft of the electric brake actuator 11 may be a direction crossing the front-rear direction of the vehicle 1.

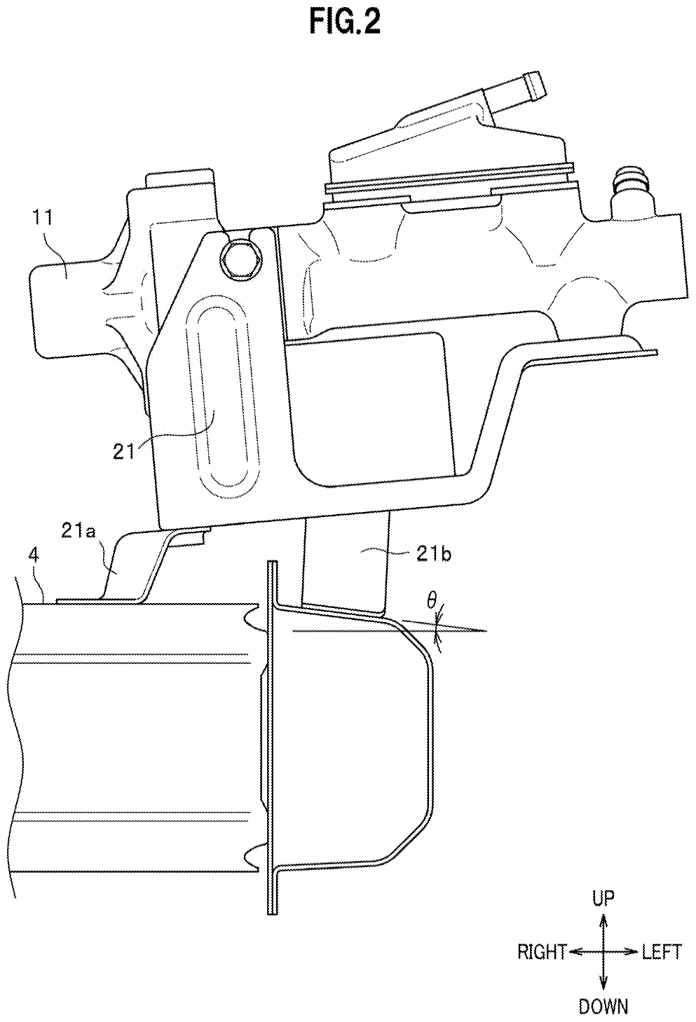

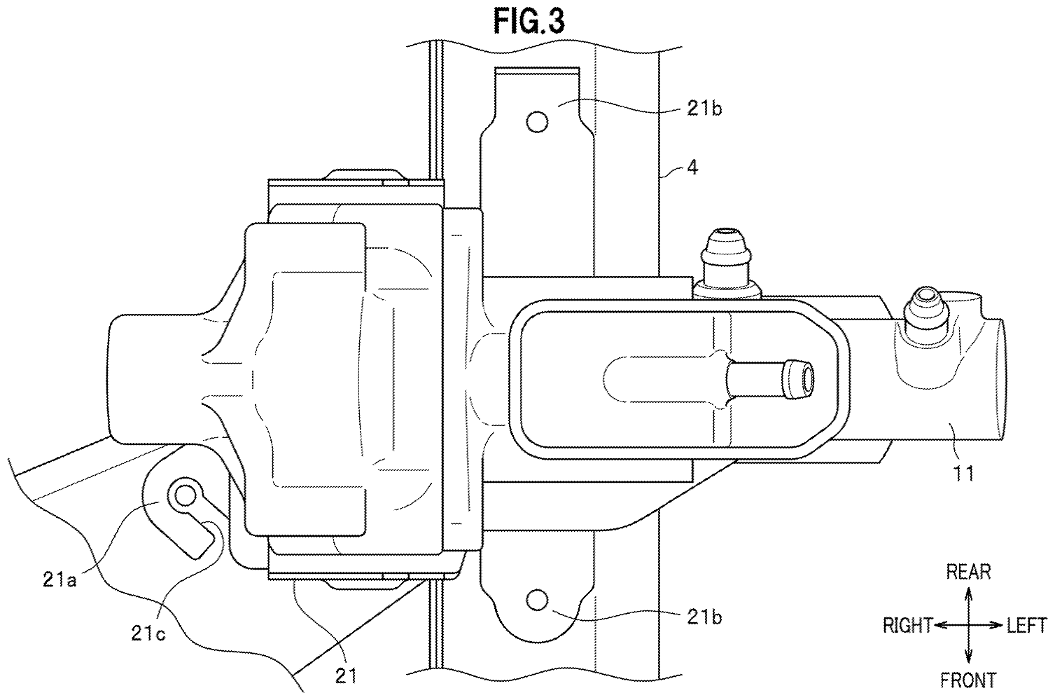

FIG. 2 is a side view of a state where the electric brake actuator 11 is attached to a side frame 4 of the vehicle 1. FIG. 3 is a plan view of the state where the electric brake actuator 11 is attached to the side frame 4 of the vehicle 1.

The electric brake actuator 11 is attached to the side frame 4 with a bracket 21. Specifically, the electric brake actuator 11 is attached to the top of the bracket 21. The bracket 21 is provided with two or more fixing portions, in this example, three fixing portions 21a and 21b. The fixing portions 21a and 21b are portions of the bracket 21 for fixing the bracket 21 to the side frame 4. Specifically, by bolting the fixing portions 21a and 21b to the side frame 4, the bracket 21 and therefore the electric brake actuator 11 can be fixed to the side frame 4.

The axial direction of the electric brake actuator 11 thus fixed to the side frame 4 via the bracket 21 is slightly tilted toward the upper right side in FIG. 2 so that the piping tube 14 can be sloped for air evacuation while connecting the electric brake actuator 11 and the reservoir tank 12.

Also, a downward slope shown by an angle θ in FIG. 2 is formed on the upper surface of the side frame 4 to which the fixing portions 21b are fixed. For this reason, when an operation of fixing the electric brake actuator 11 to the side frame 4 via the bracket 21 is performed, the electric brake actuator 11 may possibly be dropped (toward the right side in FIG. 2).

To prevent this, a notch 21c is provided in at least one of the fixing portions 21a and 21b, in this example, the fixing portion 21a. Specifically, a bolt is temporarily fixed to the position on the side frame 4 at which to fix the fixing portion 21a, and the notch 21c is hooked on this temporarily fixed bolt in advance. This reduces the possibility of the bracket 21 and therefore the electric brake actuator 11 being dropped. In this state, the fixing portions 21a and 21b are bolted to the side frame 4.

Next, advantageous effects of this embodiment will be described.

In this embodiment, the fixing point 13a for fixing the piping tube 14 is provided on the junction box 13. Thus, the piping tube 14 passes over the junction box 13. Further, the piping tube 14 connects the electric brake actuator 11 and the reservoir tank 12 via relatively the shortest path, without extending around various pieces of equipment. This enables the slope of the piping tube 14 to be relatively large. In this way, the evacuation of air in the piping tube 14 is facilitated.

Also, the axial direction of the stroke direction shaft of the electric brake actuator 11 is a direction crossing the front-rear direction of the vehicle 1 and desirably the left-right direction of the vehicle 1. In this way, the crushable zone for a collision of the front of the vehicle 1 with another vehicle or the like is larger than that in the case where the axial direction of the stroke direction shaft of the electric brake actuator 11 is the front-rear direction of the vehicle 1.

The notch 21c is provided in the fixing portion 21a. This, as described above, reduces the risk of dropping the electric brake actuator 11 when performing an operation of attaching the electric brake actuator 11 to the side frame 4.

Also, since the electric brake actuator 11 is disposed behind a headlight (not shown), there is a certain distance between the electric brake actuator 11 and the cabin of the vehicle 1. Accordingly, the sound of operation of the electric brake actuator 11 is unlikely to be heard by occupants in the vehicle 1. This can avoid giving a sense of discomfort to the occupants.

What is claimed is:

1. A front vehicle body structure of a vehicle equipped with a vehicle brake system comprising an electric brake actuator that generates a brake hydraulic pressure based on at least a brake pedal operation and a reservoir tank for a brake fluid, the electric brake actuator and the reservoir tank being disposed to be spaced apart from each other in a mounting compartment for a power unit defined in front of a dashboard,
the electric brake actuator is eccentrically disposed on a left side or a right side of the vehicle in the mounting compartment, and
a fixing point for fixing a piping tube connecting the electric brake actuator and the reservoir tank is provided on a junction box inside the mounting compartment.

2. The front vehicle body structure according to claim 1, wherein a stroke direction shaft of the electric brake actuator is disposed in a direction crossing a front-rear direction of the vehicle.

3. The front vehicle body structure according to claim 2, wherein the stroke direction shaft of the electric brake actuator is disposed in a left-right direction of the vehicle.

4. The front vehicle body structure according to claim 1, further comprising a bracket holding the electric brake actuator on the vehicle,
wherein the bracket has at least two fixing portions, and
at least one of the fixing portions has a notch.

5. The front vehicle body structure according to claim 2, further comprising a bracket holding the electric brake actuator on the vehicle,
wherein the bracket has at least two fixing portions, and
at least one of the fixing portions has a notch.

6. The front vehicle body structure according to claim 3, further comprising a bracket holding the electric brake actuator on the vehicle,
wherein the bracket has at least two fixing portions, and
at least one of the fixing portions has a notch.
